(19) United States
(12) Patent Application Publication
(10) Pub. No.: US 2003/0109171 A1
(43) Pub. Date: Jun. 12, 2003

(54) Cable harness for ATA devices

(76) Inventor: Mary B. Morgan, Huntington Beach, CA (US)

Correspondence Address: Mary B. Morgan, 215 5th St., Apt B, Huntington Beach, CA, 92648, US

(21) Appl. No.: 10/104,143

(22) Filed: Mar. 20, 2002

Related U.S. Application Data
(60) Provisional application No. 60/278,674, filed on Mar. 20, 2001.

(51) Int. Cl. H01R 11/00

(52) U.S. Cl. 439/502

(57) ABSTRACT

A cable harness construction method allowing one or multiple ATA channels to be constructed into a single harness. Thereby reducing the cross sectional area to reduce airflow attenuation and at the same time increasing the length of the cables permitting more flexible cable routing and configuration.

This patent application claims a prior filing date of the relevant provisional patent application serial No. 60/278,674 titled “Cable Harness for ATA Devices”.

### CROSS-REFERENCE

Not Applicable

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION

Many mass storage devices in use today conform to the ATA/ATAPI standards. These devices (termed ATA devices) are used in computer systems of varying types. These types can be conventional personal computers, workstations, drive arrays, file servers, network storage units etc. The ATA devices are also used to store data in instrumentation equipment, home appliances, audio and video recorders as well as many other electronic equipment.

On common thread is that the ATA devices are controlled by electronic circuitry in the system to which they are attached. The system and control circuitry are collectively know as the host. For the majority of applications the ATA devices are connected to the host controller using a flat ribbon cable.

The ANSI ATA/ATAPI-6 standard defines two types of cables to be used to connect ATA devices to the host. The cables defined consists of either 40 conductors spaced on 0.050-inch centers or 80 conductors spaced on 0.025-inch centers, both constructions result in a flat ribbon cable with a nominal width of 2 inches. The cable is connected to both the Host and the ATA device using a two-row insulation displacement connector having a nominal width of 2 inches.

Unlike the 40-conductor cable the 80-conductor variant has every other conductor connected to ground. The effect is to reduce cross talk within the cable and also provide an improved return current path because of the increased number of conductors over the lower performing 40-conductor cable. Consequently the 80-conductor construction is used to connect higher performance devices to the host.

The cabling method has been simple, low cost and satisfactory. The current trend is to increase the performance of the ATA devices, increase the performance of the Hosts and increase the number of ATA devices attached to a Host. At the same time the demand is to package the combination of Hosts and ATA devices into more physically compact enclosures. The increase in performance and number of units results in a substantial increase in the heat that is generated and thus has to be dissipated. The heat is best dissipated by increasing the airflow through the enclosure and around the various components within the enclosure. One of the impediments to the airflow is the relatively wide ATA cable. The increase in the number of ATA devices in the enclosure results in an increase in the number of cables with a subsequent substantial probability that areas of the enclosure will be starved of a sufficient flow of air to cool the components.

U.S. Pat. No. 6,058,604 (Cable for allowing mass storage device address selection) defines a method for setting device addresses by a cable construction method. It does not address the airflow restriction problems or the restriction of cable length.

The objective of this invention is to provide a cable construction method that both increases the usable cable length and reduces the cross sectional area of the cable. The increase in length allows ATA devices to be used in systems that are currently prohibited by the 18 inch length restriction. The reduction in cross sectional area reduces the restriction to air flow thereby increasing cooling.

### BRIEF SUMMARY OF THE INVENTION

This invention is for a harness construction method that makes use of twisted pair stands and a loose sheath to reduce the effects of cross talk thereby permitting longer cable lengths and reduced cross sectional.

### BRIEF DESCRIPTION OF THE DRAWINGS

Drawings-List of Figures

FIG. 1. A bundled solution for two hosts and four devices.

FIG. 2. A bundled solution for two host and two devices.

FIG. 3. 80 conductor, loose stranded cable with one host and two devices.

FIG. 4. 80 conductor loose stranded cable, where each cable is separated and bundled at key electrical conductor points.

### REFERENCE NUMERALS

1. 40 pin to 80 conductor Insulation Displacement Connector (IDC) connecting the host's primary channel to the 40 twisted pair cable.

2. 40 twisted conductor pairs from the host's primary connector drawn together.

3. Loose conductor pairs kept together with a band or molded shield.

4. Sheath terminator used to hold the sheath and cable in position.

5. Sheath.

6. 40 twisted conductor pairs for the primary channel expanding from the main sheath.

7. 40 pin to 80 conductor Insulation Displacement Connector (IDC) connecting the intermediate ATA/ATAPI device on the primary channel to the 40 twisted pair cable.

8. 40 twisted conductor pairs from the intermediate device connector on the primary channel drawn together.

9. Optional sheath terminator used to hold the optional sheath and cable in position.

10. Optional intermediate sheath.

11. The primary channel's 40 twisted conductor pairs cable expanding from the optional sheath.

12. 40 pin to 80 conductor Insulation Displacement Connector (IDC) connecting the end ATA/ATAPI device on the primary channel to the 40 twisted pair cable.

13. 40 pin to 80 conductor Insulation Displacement Connector (IDC) connecting the host's secondary (or subsequent) channel to the 40 twisted pair cable.

14. 40 twisted conductor pairs from the host's secondary connector drawn together.

15. 40 twisted conductor pairs for the secondary channel expanding from the main sheath.

16. 40 pin to 80 conductor Insulation Displacement Connector (IDC) connecting the intermediate ATA/ATAPI device on the secondary channel to the 40 twisted pair cable.

17. 40 twisted conductor pairs from the intermediate device connector on the secondary channel drawn together.

18. The secondary channel's 40 twisted conductor pairs cable expanding from the optional sheath.

19. 40 pin to 80 conductor Insulation Displacement Connector (IDC) connecting the end ATA/ATAPI device on the secondary channel to the 40 twisted pair cable.

### DETAILED DESCRIPTION OF THE INVENTION

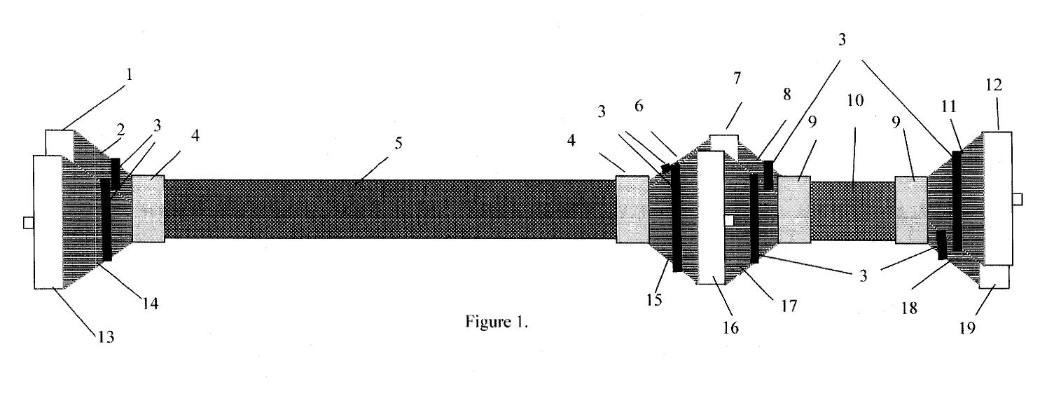

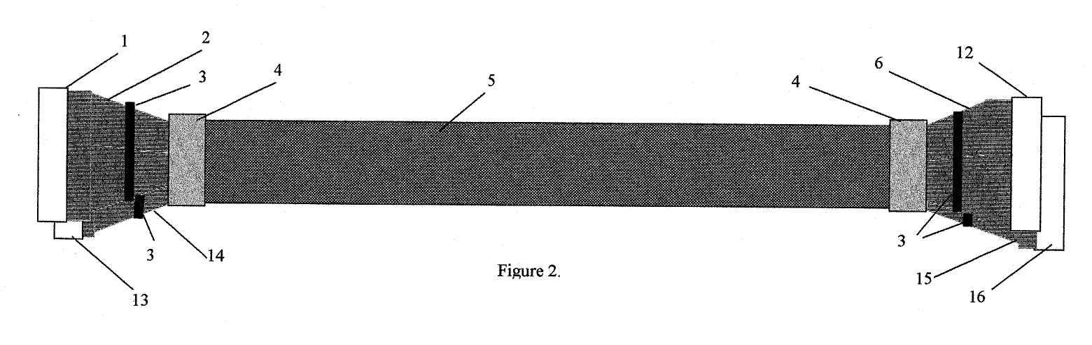

The obstruction to the airflow caused by the cables is substantially reduced by decreasing the cross section of the cable. To do this the cable is constructed of loose insulated conductors, however individual conductors would loose one of the attributes of the 80-conductor construct, namely reduction of cross talk. By using pairs of strands that are twisted together (commonly known as twisted pairs) and ensuring that one of the pair is a ground, cross talk reduction can be maintained. The result is a collection of twisted pair conductors forming a cable as illustrated in by items 2 and 14 in FIGS. 1 and 2.

The loose pairs would be susceptible to damage if not protected. This protection is provided by a sheath. More than one cable may be contained within one sheath forming what is termed a harness.

In ATA systems the return current in the conductor pair does not exactly match the supply current as dictated in classic twisted conductor theory. Thus the radiated electromagnetic emissions are not eliminated but are still reduced giving a reduction but not elimination of cross talk. To reduce cross talk further the conductors should not exactly follow parallel paths. To accomplish this the cross sectional area of the sheath should be greater than the combined cross sectional areas of the insulated conductors contained within it to allow movement and some element of random distribution of the conductors. The ratio of sheath cross sectional area to the combined cross sectional areas of the insulated conductors will depend on the exact implementation. A ratio of two to one or more will cover most configurations. This bundling may be accomplished by a variety of means, for example heat shrink tubing, sheathing, spiral wrap and other methods provided that the combination of the conductors and the sheath results in flexible harness. The location of the sheaths are illustrated as items 5 and 10 in FIGS. 1 and 2.

Because the sheaths have to be a loose fit they have to be constrained by some form of band at each end. Such a band is illustrated as item 4 and 9 in FIGS. 1 and 2. The loose conductor pairs fan out from the sheath to mate with the connectors as shown as items 2,6,8,11,14,15,17 and 18 in FIGS. 1 and 2. The loose stranding of the wires make it necessary to constrain and protect them in by some method. Items 3 in FIGS. 1 and 2 show bands that may be implemented using a variety of means including shrink wrap with internal adhesive to prevent slippage or tie wraps. A molded sheath in the form of a flat cone may also be used provided that the protection provided it is not too stiff to as to prevent easy routing.

If the distance between intermediate connector and the end device connector is small an intermediate sheath (item 10 in FIG. 1) may not be needed.

The combined effects of the twisted pair construction and the loose stranding and random nature of the proximity of the conductors reduce the cross talk in comparison to the standard flat ribbon cable defined within the ATA standard. This reduction per unit length permits cable harnesses to be constructed well in excess of the standard length and still conform to the overall allowable cross talk.

Air flow attenuation is reduced by using the harness in at least two ways. The first is due to the extra length and flexibility of the assembly which facilitates easy routing of the harness away from sensitive areas. The second is the reduction in cross sectional area in some cases by approximately 800% over the standard cable. By reducing the obstruction of the airflow system cooling is greatly enhanced thereby increasing system reliability. The use of twisted pairs within a loose fitting sheath improves signal integrity by reducing EMI and cross talk.

This type of construction allows the cables to be bundled into a small cross section reducing the restriction to air flow thereby increasing cooling of the systems they are used in.

The construction method results in a flexible construction resulting in easier routing.

There are other benefits to making these harnesses. The cables are now neater and more easily routed. This in turn improves accessibility for those working on the systems with the resultant reduction in the possibility of human errors.

What I claim is:

1. A method of constructing a cable to transmit the various ATA standard protocols between a host system and one or more ATA/ATAPI devices. Said cable consists of:
A multitude of twisted pairs of insulated conductors;
A connector at one end of the set of conductors to connect to the host system;
A connector a the opposite end of the set of conductors to connect to an ATA/ATAPI device.
An optional intermediate connector for connection of the conductors to an optional second ATA/ATAP device.

2. A method according to claim one whereby said conductor pairs are connected using said connectors such that one conduction of the pair transmits a signal while the other conductor provides a ground return path.

3. A method according to claim one where by two or more of said cables are contained within a sheath to form a cable harness. Whereby said sheath's cross sectional area is sufficiently greater than the combined cross sectional areas of the conductors in said cables.

4. A method according to claim 2 and claim 3 whereby the cross talk is reduced allowing longer cable harnesses to be constructed with the same overall cross talk as a standard cable.
